(19) United States
(12) Patent Application Publication
(10) Pub. No.: US 2014/0085084 A1
(43) Pub. Date: Mar. 27, 2014

(54) PASSIVE ACTIVE BATTERY SAVER TRACKING SYSTEM

(71) Applicant: Loran Technologies, Inc, Carson City, NV (US)

(72) Inventor: Ohanes Der Ghazarian, Beirut (LB)

(21) Appl. No.: 13/905,861

(22) Filed: May 30, 2013

Related U.S. Application Data
(60) Provisional application No. 61/744,541, filed on Sep. 27, 2012.

(51) Int. Cl. H04W 4/02

(52) U.S. Cl. CPC H04W 4/021
USPC 340/539.13

(57) ABSTRACT

An active/passive tracking device is provided. The device includes a position locator configured to receive location information of the device. The device also includes a processor configured to determine whether the device is within, or proximate to, a geo-fenced area based on the received location information. The processor is further configured to deactivate the position locator of the device to conserve the power when the processor determines the device is within, or proximate to, the geo-fenced area.

### CROSS-REFERENCE TO RELATED APPLICATION

This application claims the benefit of U.S. Provisional Patent application Ser. No. 61/744,541, filed on Sep. 7, 2012. The subject matter of this earlier filed application is hereby incorporated herein by reference in its entirety.

### FIELD

The present invention relates to battery saving mechanism and, more particularly, to a tracking system having a passive/active battery saving mechanism.

### BACKGROUND

Presently, there are methods to reduce power consumption in portable tracking devices. For instance, a processor of a portable tracking device may be programmed to switch a global positioning satellite (GPS) receiver to sleep mode to reduce power consumption, and the processor at time intervals may activate the GPS receiver to coordinate location of the portable tracking device.

However, by switching the GPS receiver between sleep mode and active mode, real time tracking or real time location data logging cannot be achieved due to the inactivity of the GPS receiver at certain time periods. For example, a person whose movements are being tracked needs to be logged regardless of whether the subject matter is located within, or outside of, a predefined geo-fenced area of a home base unit. In such cases, constant switching of the GPS receiver between sleep mode and active mode is not ideal.

### SUMMARY

Certain embodiments of the present invention may provide solutions to the problems and needs in the art that have not yet been fully identified, appreciated, or solved by current methods to save power in a tracking device.

In accordance with one embodiment, an apparatus is provided. The apparatus includes a position locator configured to receive location information of the apparatus. The apparatus also includes a processor configured to determine whether the apparatus is within, or proximate to, a geo-fenced area based on the received location information. The processor is further configured to deactivate the position locator of the tracking device to conserve the power of the apparatus when the processor determines the apparatus is within, or proximate to, the geo-fenced area.

In another embodiment of the present invention, an apparatus is provided. The apparatus includes a position locator configured to receive location information of the apparatus. The apparatus also includes a processor configured to determine whether the apparatus is within, or proximate to, a geo-fenced area based on the received location information. The processor is further configured to deactivate the radio frequency transceiver of the tracking device to conserve the power of the apparatus when the processor determines the apparatus is within, or proximate to, the geo-fenced area.

In yet another embodiment of the present invention, the apparatus includes a position locator configured to receive positioning information. The apparatus also includes a radio frequency transceiver configured to establish radio frequency communication with, and transmit the received positioning information to, a monitoring station. The apparatus further includes a radio frequency identifier transceiver configured to communicate with a home base unit. When the apparatus is in a predefined radio frequency communication range with the home base unit, a processor is configured to cause the radio frequency identifier transceiver to establish radio frequency communication with the home base unit and deactivate the position locator, the radio frequency transceiver, or both, to conserve power of the tracking device. The processor is further configured to activate a position locator, the radio frequency, or both, when a tamper of the apparatus, a low power supply of the apparatus, or both, is detected.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a tracking system, according to an embodiment of the present invention.

FIG. 2 is a block diagram illustrating a passive active tracking system, according to an embodiment of the present invention.

### DETAILED DESCRIPTION OF THE EMBODIMENTS

Embodiments of the present invention pertains to a passive/active tracking system configured to activate and deactivate a position locator, RF transceiver, or both, depending on the location of the tracking device to conserve the power supply of the tracking device.

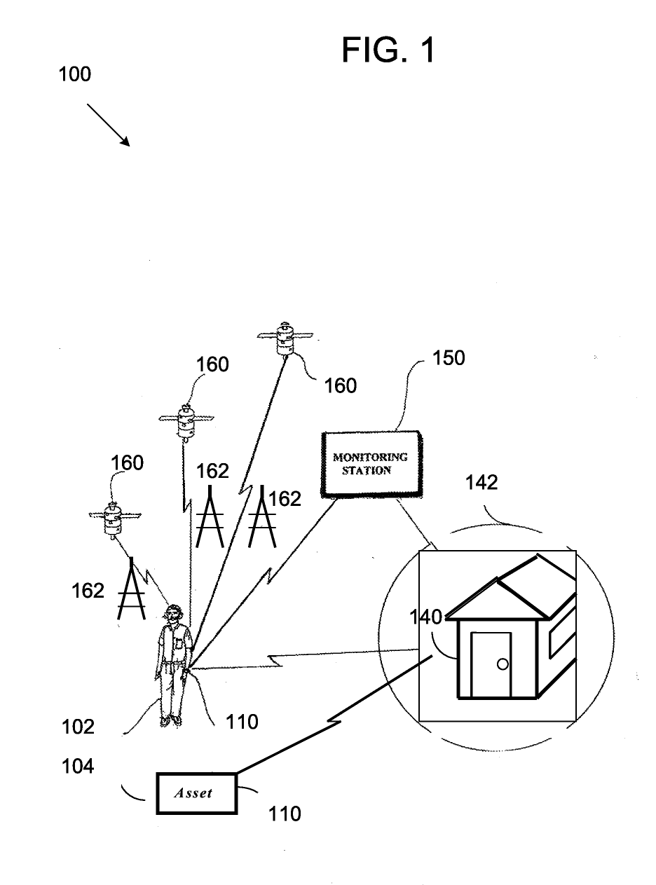

FIG. 1 is a diagram 100 illustrating a tracking system, according to an embodiment of the present invention. In this embodiment, tracking system includes a person 102 or an object 104 carrying a tracking device 110. Object 104 may be a package in certain embodiments. Tracking device 110 may include a tamper detection strap or mountable unit (not shown) and tamper detection sensor (also not shown). The tamper detection strap, or mountable unit, is configured to securely attach tracking device 110 to person 102 or object 104. The tamper detection sensor is configured to detect whether the tamper detection strap, mountable unit, or tracking device 110 has been tampered with or removed.

Tracking system may also include a geo-fenced area 142. The data related to geo-fenced area 142 may be preloaded or previously stored in memory (not shown) of tracking device 110. It should be appreciated that one or more geo-fenced areas may be preloaded in memory of tracking device 110. For example, in certain embodiments, there may more than one geo-fenced area 142 and, for each geo-fenced area, data related each of the geo-fenced area may be pre-loaded in memory of tracking device 110.

Tracking device 110, in this embodiment, may communicate with monitoring station 150 via home base unit 140, at least one satellite 160, at least one base station 162, at least one radio frequency relay station, at least one cellular site, or any combination thereof. Base station 162 may include a cellular site, radio frequency relay tower, etc.

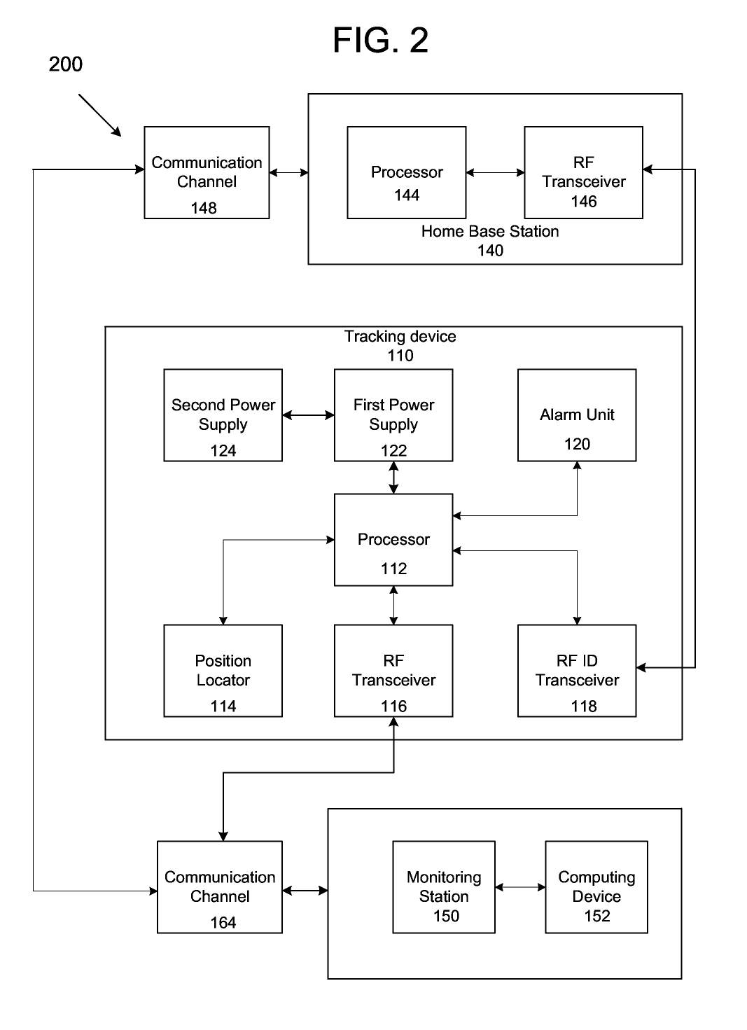

As shown in FIG. 2, tracking device 110 may include a processor 112 and a position locator 114. Position locator 114 may be configured to determine a location (or location/position information) of tracking device 110. The location of tracking device 110 may be determined based on signals received from positioning satellites 160.

Position locator 114 may transmit location information of tracking device 110 to a processor 112. It should be appreciated that in certain embodiments, position locator 114 may be a GPS receiver. However, in other embodiments, position locator 114 may be any device configured to determine the location of tracking device 110 by receiving location signal from radio relay stations or cellular sites. It should also be appreciated that position locator 114 may continuously or periodically receive location information from positioning satellite 160, radio relay station, or cellular sites.

Tracking device 110 also includes a radio frequency (RF) transceiver (or RF transceiver module) 116. RF transceiver 116 may be configured to transmit data using long range RF communication or cellular communication. For instance, RF transceiver 116 may transmit location information of tracking device 110 to a monitoring station 150 via at least one base station 162, radio relay station, satellite, or cellular site.

As discussed above, tracking system includes a geo-fenced area 142. In certain embodiments, position locator 114 can receive location information identifying whether a person 102 or an object 104 is in proximity to, or within, geo-fenced area 142. When a person 102 or an object 104 is within proximity of, or within, geo-fenced area 142, processor 112 is configured to deactivate position locator 114 to conserve power, i.e., switch position locator 114 to standby mode or an off state. For example, processor 112, upon receipt of the location information from position locator 114, may determine that tracking device 110 is within geo-fenced area 142 and may deactivate position locator 114. It should be appreciated that position locator 114 may remain deactivated until the tracking device is operating on low battery, tampering of the tracking device has been detected, the tracking device has moved outside of geo-fenced area, etc.

In order to maintain continuous communication of location information of tracking device 110 to monitoring station 150, RF transceiver 116 is configured to transmit location information to monitoring station 150. It should be noted that, in certain embodiments, when tracking device 110 moves out of proximity, or outside of, geo-fenced area 142, RF transceiver 116 is configured to receive change in location information of radio frequency relay station or cellular site when position locator 114 is deactivated. For instance, RF transceiver 116 may receive location information of at least one radio frequency relay station or cellular site. In other embodiments, RF transceiver 116 may receive triangulation signal from cellular site or radio relay station to enable processor 112 so monitoring station 150 can determine the location of tracking device 110. Further, in certain embodiments, at least one Doppler signal may be used to determine location of tracking device 110.

Since RF transceiver 116 receives relay station or cellular site location information when position locator 114 is deactivated, processor 112 is configured to cause RF transceiver 116 to transmit the received relay station or cellular sites location information to monitoring station 150 to allow monitoring station 150 to determine whether tracking device 110 has moved outside of geo-fenced area 142. For example, as tracking device 110 moves, a signal from another relay station or cellular tower may be received by RF transceiver 116. This received signal is then transmitted to monitoring station 150 allowing monitoring station 150 to determine whether tracking device 110 has moved outside of geo-fenced area 142. If tracking device 110 has moved outside of geo-fenced area 142, processor 112 may activate position locator 114.

It should be appreciated that position locator 114 is configured to receive location information of tracking device 110 as a person 102 or an object 104 is in motion or is stationary, and may transmit the location information to processor 112. To continuously or periodically update monitoring station 150 regarding the position of tracking device 110, processor 112 is configured to cause RF transceiver 116 to periodically or continuously transmit the location information of tracking device 110 to monitoring station 150 via at least one radio relay station, cellular site, or satellite.

In one embodiment, when tracking device 110 is within, or proximate to, geo-fenced area 142, processor 112, in response to receiving location information from position locator 114, may determine that tracking device 110 is within, or proximate to geo-fenced area 142. In such an embodiment, processor 112 may deactivate RF transceiver 116 to conserve power. Further, prior to deactivating RF transceiver 116, processor 112 is configured to cause RF transceiver 116 to transmit the location information to monitoring station 150. The location information is configured to personnel operating computing device 152 that tracking device 110 is within or proximate to geo-fenced area 142.

It should be noted that, in some embodiments, position locator 114 may remain active to continuously (or periodically) receive location information of tracking device 110 while RF transceiver 116 remains deactivated. This allows processor 112 to determine whether person 102 or object 104 carrying tracking device 110 has moved outside of, or away from, geo-fenced area 142 based on updated location information received by position locator 114. When tracking device 110 is outside of, or away from, geo-fenced area 142, processor 112 may activate RF transceiver 116 to enable communication with monitoring station 150, such that updated location information of tracking device 110 is transmitted to monitoring station 150.

In certain embodiments, position locator 114, radio frequency transceiver, or both may also be deactivated when tracking device 110 is located within radio frequency communication proximity to a home base unit 140. In some embodiments, RF identifier transceiver 118 may automatically establish radio frequency communication with home base unit 140 when RF identifier transceiver 118 becomes within communication proximity to home base unit 140. In another embodiment, however, RF identifier transceiver 118 may be activated to allow short range radio frequency communication with home base unit 140. For example, RF identifier transceiver 118 may be configured to communicate to a RF transceiver 146 of home base unit 140. It should be appreciated that RF identifier transceiver 118 may periodically or continuously communicate with RF transceiver 146 of home base unit 140. This may allow home base unit 140 to communicate the location information of tracking device 110 to monitoring station.

When home base unit 140 receives communication from RF identifier transceiver 118, processor 144 of home base unit 140 is configured to transmit a message to monitoring station 150 via a first communication channel 148 and a second communication channel 164. First communication channel 148 may include a land line, cellular modem, satellite, or any combination thereof, and second communication channel 164 may include RF relay towers, cell towers, satellites, land line, or any combination thereof. The transmitted message may inform monitoring station 150 that tracking device 110 is located within or is proximate to geo-fenced area 142.

Because RF identifier transceiver 118 may communicate over short range, processor 112 can determine that tracking device 112 has moved away or outside of geo-fenced area 142 when communication between RF identifier transceiver 118 and RF transceiver 146 of home base unit 140 is lost or terminated. When radio frequency communication is lost with home base unit 140, processor 112 is configured to activate position locator 114, RF transceiver 116, or both, in order to receive updated location information. It should also be appreciated that, in some embodiments, the radio frequency identifier transceiver upon loss of radio frequency communication with the home base unit 140, RF identifier transceiver 118 may be deactivated to conserve battery. Upon receipt of the updated location information, processor 112 is configured to cause RF transceiver 116 to transmit the updated location information to monitoring station 150. The updated location information in this embodiment informs monitoring station 150 that tracking device has moved outside of proximity of home base unit 140.

Tracking device 110 also includes a low power detection circuitry (not shown) operably connected to a first power supply 122, a second power supply 124, and processor 112. In embodiments where position locator 114, RF transceiver 116, or both, are deactivated, and when low power detection circuitry detects first power supply 122 has low power, processor 112 is configured to activate position locator 114, RF transceiver 116, or both. By activating position locator 114, location information may be obtained from, for example, positioning satellite 160. Furthermore, RF transceiver 116 may transmit a signal identifying low power to monitoring station 150. It should be noted that in some embodiments that the transmitted signal may also include location information identifying the location of tracking device 110.

However, in other embodiments, a first signal identifying low power may be transmitted followed by a second signal identifying the location of tracking device 110 may be transmitted, or vice-versa. This not only allows monitoring station 150 to receive updates regarding the location of tracking device 110, but also allows monitoring station 150 to transmit an alarm signal to alarm unit 120 to inform person 102 that tracking device 110 has low power. In certain embodiments, alarm unit 120 may cause tracking device 110 to vibrate or issue an audio alert to person 102, when the tracking device processor detect low power condition.

In some embodiments, first power supply 122, second power supply 124, or both, may be replaceable and/or rechargeable power supplies. In cases where first power supply 122 is operating at low power, second power supply 124 may connect to, and recharge, first power supply 122 until first power supply 122 includes sufficient power to operate tracking device 110.

As discussed above, tracking device 110 also includes tamper detection sensor configured to detect whether the tamper detection strap, tracking device 110, or both, have been tampered with. For example, tamper detection sensor may detect whether the tracking device has been removed. In embodiments where position locator 114, RF transceiver 116, or both, are deactivated, and when tamper detection sensor detects a tamper, processor 112 is configured to activate position locator 114, RF transceiver 116, or both. This allows processor 112 to receive location information obtained by position locator 114 and cause RF transceiver 116 to transmit a signal including tamper detection information, location information, or both, to monitoring station 150. Tamper detection information may include a tamper detection alert, a condition of the tamper, time of tamper, etc. This allows monitoring station 150 to transmit an alarm signal to alarm unit 120 to inform person 102 that he or she is tampering with tracking device 110.

In the event that lower power detection circuitry and tamper detection sensor detect low power and tamper simultaneously or shortly one after another, processor 112 is configured to activate position locator 114, RF transceiver 116, or both, when position locator 114, RF transceiver 116, or both are deactivated. As a result, position locator 114 may retrieve the location information at the time of tamper, and RF transceiver 116 may transmit location information at the time of tamper, tamper detection information, low power information, etc., to monitoring station 150.

Certain embodiments of the present invention pertain to a passive active tracking system. The system includes a tracking device securely attached to a person or an object. The tracking device may include a first power supply to supply power to the tracking device, a processor configured to control the functional operation of the tracking device, such as the position locator, the RF transceiver, the RF identifier transceiver, etc.

The position locator in certain embodiments is configured to receive location information from at least one positioning satellite. The RF transceiver is configured to establish radio frequency communications with, and transmit the received location information of the tracking device to, a monitoring station. The RF identifier transceiver is configured to communicate with home base unit when the tracking device is proximate to, or within, a home base unit.

When the tracking device is out of communication range with the home base unit, the RF identifier transceiver may lose communication signal with the home base unit. This may cause the processor to activate the position locator, the RF transceiver, or both, to provide location information of the tracking device to the monitoring station. When the tracking device is located within RF communication range (e.g., short communication range), or within the home base unit, the RF identifier transceiver is configured to establish radio frequency communication with the home base unit and the processor is configured to deactivate the position locator, the RF transceiver, or both, to conserve power of the tracking device.

In another embodiment, when the tracking device is located within proximity of home base unit, the locator receiver, the RF transceiver, or both, are configured to deactivate. However, when the tamper detection sensor detects tampering of the tamper detection strap or removal of the tracking device, the processor is configured to activate the position locator, the RF transceiver, or both, to transmit the tamper detection condition, the location information of the tamper, or both, to the monitoring station.

The tracking device may also include low power detection circuitry to detect when the power supply of the tracking device has insufficient power to operate the tracking device. When the tracking device is located within the proximity of home base unit, and when the position locator receiver, the RF transceiver, or both are deactivated, the processor, in response to receiving an alert from the low power detection circuitry, is configured to activate the position locator, the RF transceiver, or both, to transmit the low power condition, along with the location of the tracking device, to the monitoring station.

Furthermore, when the tracking device is within proximity of home base unit, and when the position locator, the RF transceiver, or both, are deactivated, the processor, in response to receiving a detecting tamper detection signal from the tamper detection sensor, is configured to activate the position locator to coordinate location information of the tracking device, the RF transceiver to receive relay station or cellular site location information in which the tracking device is located, or both. The processor is further configured to cause the RF identifier transceiver to transmit the tamper detection condition and location to the monitoring station via the relay station, cellular site(s) or home base unit.

In other embodiments, when the tracking device is located within proximity of home base unit, and when position locator, the RF transceiver module, or both, are deactivated, the processor, in response to receiving an insufficient power supply notification from the low power detection circuitry, is configured to activate positioning locator to coordinate location information of the tracking device, the RF transceiver to receive the relay station or cellular site location information in which the tracking device is located, or both. Using the location information, the processor is configured to cause the RF identifier transceiver to transmit a low power supply condition, as well as the relay station or cellular site location information, to the monitoring station via the relay station, cellular site or the home base unit.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a position locator configured to receive location information of the apparatus;
a processor configured to determine whether the apparatus is within, or proximate to, a geo-fenced area based on the received location information, wherein
the processor is further configured to deactivate the position locator of the tracking device to conserve the power of the apparatus when the processor determines the apparatus is within, or proximate to, the geo-fenced area.

2. The apparatus of claim 1, further comprising:
a strap or a mountable unit configured to securely attach to a person or an object; and
a tamper detection sensor configured to detect tampering of the strap, tampering of the mountable unit, or removal of the apparatus, or a combination thereof.

3. The apparatus of claim 1, wherein, prior to deactivating the position locator, a radio frequency transceiver configured to transmit the received location information to a monitoring station when the apparatus is within, or in proximity to, the geo-fenced area.

4. The apparatus of claim 1, wherein, when the apparatus moves outside of the geo-fenced area, and a radio frequency transceiver receives a change in location information of radio frequency relay station, cellular tower, or Doppler signal, the processor is configured to activate the position locator.

5. The apparatus of claim 4, wherein the radio frequency transceiver is configured to transmit the change in location information to a monitoring station.

6. The apparatus of claim 4, wherein, the position location is configured to receive updated location information from a positioning satellite, and the processor is configured to cause the radio frequency transceiver to transmit the updated location information to a monitoring.

7. The apparatus of claim 1, wherein data related to the geo-fenced area is preloaded in memory of the apparatus.

8. The apparatus of claim 1, wherein, when position locator is deactivated, and, when low power of apparatus is detected, tamper of the apparatus is detected, or both, the processor is further configured to activate the position locator to receive updated location information and cause a radio frequency transceiver to transmit the updated location information, a low power condition of the apparatus, a tamper condition of the apparatus, or a combination thereof.

9. The apparatus of claim 1, wherein, when position locator is deactivated, and, when low power of apparatus is detected, tamper of the apparatus is detected, or both, the processor is further configured to cause a radio frequency transceiver to
receive updated location information of a relay station, cellular tower, a base station, or a combination thereof, and
transmit updated information, a low power condition of the apparatus, a tamper condition of the apparatus, or a combination thereof.

10. The apparatus of claim 1, further comprising:
at least one power supply configured to supply power to the apparatus; and
a low power supply detection circuitry configured to detect when power supply of the at least one power supply is low, and generate an alarm signal to a user.

11. An apparatus, comprising:
a position locator configured to receive location information of the apparatus;
a processor configured to determine whether the apparatus is within, or proximate to, a geo-fenced area based on the received location information, wherein
the processor is further configured to deactivate the radio frequency transceiver of the tracking device to conserve the power of the apparatus when the processor determines the apparatus is within, or proximate to, the geo-fenced area.

12. The apparatus of claim 11, further comprising:
a strap or a mountable unit configured to securely attach to a person or an object; and
a tamper detection sensor configured to detect tampering of the strap, tampering of the mountable unit, or removal of the apparatus, or a combination thereof.

13. The apparatus of claim 11, wherein, prior to deactivating the radio frequency transceiver, the processor is further configured to cause the radio frequency transceiver to transmit the received location information to a monitoring station when the apparatus is within, or in proximity to, the geo-fenced area.

14. The apparatus of claim 11, wherein, the processor is further configured to activate the radio frequency transceiver when, based on updated location information received by the position locator, the processor determines the apparatus is outside of the geo-fenced area.

15. The apparatus of claim 14, wherein the position locator is further configured to receive the updated location information of the apparatus from at least one positioning satellite.

16. The apparatus of claim 15, wherein, in response to receiving the updated location information from the position locator, the radio frequency transceiver, when activated, is further configured to transmit the updated location information of the apparatus to a monitoring station when the processor determines the apparatus is outside of the geo-fenced area.

17. The apparatus of claim 11, wherein data related to the geo-fenced area is preloaded in memory of the apparatus.

18. The apparatus of claim 11, wherein, when radio frequency transceiver is deactivated, and, when low power of apparatus is detected, tamper of the apparatus is detected, or both, the processor is further configured to activate the radio frequency transceiver to transmit a low power condition of the apparatus, a tamper condition of the apparatus, or a combination thereof.

19. The apparatus of claim 11, wherein, when radio frequency transceiver is deactivated, and, when low power of apparatus is detected, tamper of the apparatus is detected, or both, the processor is further configured to activate the radio frequency transceiver and cause the radio frequency transceiver transmit updated information, based on updated location information of a radio relay station, cellular tower, or base station, a low power condition of the apparatus, a tamper condition of the apparatus, or a combination thereof.

20. The apparatus of claim 11, wherein, when radio frequency transceiver is deactivated, and, when low power of apparatus is detected, tamper of the apparatus is detected, or both, the processor is further configured to cause the position locator to receive updated location information and activate the radio frequency transceiver to transmit the updated location information, a low power condition of the apparatus, a tamper condition of the apparatus, or a combination thereof.

21. The apparatus of claim 11, further comprising:
at least one power supply configured to supply power to the apparatus; and
a low power supply detection circuitry configured to detect when power supply of the at least one power supply is low, and generate an alarm signal to a user.

22. An apparatus, comprising:
a position locator configured to receive positioning information; and
a radio frequency transceiver configured to establish radio frequency communication with, and transmit the received positioning information to, a monitoring station; and
a radio frequency identifier transceiver configured to communicate with a home base unit, wherein
when the apparatus is in a predefined radio frequency communication range with the home base unit, a processor is configured to cause the radio frequency identifier transceiver to establish radio frequency communication with the home base unit and deactivate the position locator, the radio frequency transceiver, or both, to conserve power of the tracking device,
the processor is further configured to activate a position locator, the radio frequency, or both, when a tamper of the apparatus, a low power supply of the apparatus, or both, is detected.

23. The apparatus of claim 22, further comprising:
a tamper detection circuitry configured to detect tampering of the apparatus.

24. The apparatus of claim 23, wherein, when the tamper detection circuitry detects tampering of the apparatus, the processor is further configured to activate the position locator, the radio frequency transceiver, or both, to transmit a tamper detection condition to the monitoring station.

25. The apparatus of claim 24, wherein, when the apparatus is located within proximity of the home base unit, and when the tamper detection circuitry detects tampering of the apparatus, the processor is further configured to
activate the positioning locator to receive positioning information of the apparatus, the radio frequency transceiver to determine the positioning information of the apparatus, or both, to coordinate positioning information of the apparatus, and
cause the radio frequency identifier transceiver to transmit tamper detection condition to a monitoring station via the home base unit, land line, cellular, RF relay station, or satellite modem.

26. The apparatus of claim 22, further comprising:
at least one power supply configured to supply power to the apparatus; and
a low power supply detection circuitry configured to detect when power supply of the at least one power supply is low, and generate an alarm signal to a user.

27. The apparatus of claim 26, wherein, when the low power supply detection circuitry detects low power, the processor is further configured to activate the position locator, the radio frequency transceiver, or both, to transmit at least one low battery detection condition signal to a monitoring station.

28. The apparatus of claim 26, wherein, when the apparatus is located within proximity of the home base unit, and when the low power supply detection circuitry detects low power, the processor is further configured to
activate the position locator, the radio frequency transceiver, or both, to coordinate positioning information of the apparatus, and
cause the radio frequency identifier transceiver to transmit the at least one low battery detection condition to the monitoring station via the home base unit land line, cellular, RF relay towers or satellite.

29. An apparatus of claim 22, wherein, when the apparatus enters a geo-fenced area, the processor is configured to deactivate the positioning locator, the radio frequency transceiver, or both, and activate the radio frequency identifier transceiver to establish communication with the home base unit, and
when the apparatus moves away from radio frequency communication proximity of the home base unit, the processor is further configured to activate the position locator, the radio frequency transceiver, or both, and deactivate the radio frequency identifier transceiver to conserve battery.
